(19) United States
(12) Patent Application Publication
(10) Pub. No.: US 2009/0155442 A1
(43) Pub. Date: Jun. 18, 2009

(54) METHOD FOR ENHANCING DELIVERY AND UNIFORMITY OF CONCENTRATION OF DIETARY INGREDIENTS

(75) Inventors: Marvin A. Heuer, Mississauga (CA); Ken Clement, Mississauga (CA); Jason Peters, Mississauga (CA); Shan Chaudhuri, Brampton (CA)

Correspondence Address: TORYS LLP, 79 WELLINGTON STREET WEST, SUITE 3000, BOX 270, TD CENTRE, TORONTO, ON, M5K 1N2, CA

(73) Assignee: MULTI FORMULATIONS LTD., Mississauga (CA)

(21) Appl. No.: 11/958,767

(22) Filed: Dec. 18, 2007

(51) Int. Cl. A23L 2/40; A23L 1/29

(52) U.S. Cl. 426/561

(57) ABSTRACT

An effervescent dietary composition for enhancing the delivery of a dietary ingredient to a human comprises dissolving an effervescent containing dietary ingredient and two ingredients capable of reacting to produce effervescence in water. Once the mixture has completely dissolved the solution is immediately ingested, and an effective amount of a dietary ingredient is absorbed. Preferably, the effervescent is in the form of a tablet which contains a dietary ingredient, and a mixture of acids, and basic salts.

### FIELD OF THE INVENTION

The present invention relates generally to oral dietary supplements, and more particularly to effervescent dietary compositions for enhancing the delivery of dietary ingredients in a human.

### BACKGROUND OF THE INVENTION

Obesity has become an increasingly widespread and predominant health concern. According to the World Health Organization (WHO) obesity is considered a multifactorial chronic disease which is increasing in frequency (Curioni C, Andre C, Veras R. Weight reduction for primary prevention of stroke in adults with overweight or obesity. Cochrane Database Syst Rev. Oct. 18, 2006;(4):CD006062). Obesity, a condition of excessive body fat, generally results from more energy (food) being consumed than is being used. Stemming from excessive body fat, several health-related concerns such as increased morbidity have linked to obesity and being overweight as well as hypertension, coronary heart disease, type 2 diabetes mellitus, stroke and even some forms of cancer (Curioni C, Andre C, Veras R. Weight reduction for primary prevention of stroke in adults with overweight or obesity. Cochrane Database Syst Rev. Oct. 18, 2006;(4):CD006062).

Not surprisingly, a great deal of effort has gone into addressing the problems created by excessive weight. Fad diets, diet pills, diet foods, liposuction, intestinal bypass surgery, and lifestyle changes have all been advanced as solutions to the problem of overweight, some with greater success than others.

The discovery of the adipostatic hormone leptin in 1994 brought forth the realization that, in certain cases, obesity may have a biochemical basis (Zhang Y, Proenca R, Maffei M, Barone M, Leopold L, Friedman J M. Positional cloning of the mouse obese gene and its human homologue. Nature. Dec. 1, 1994;372(6505):425-32). Discoveries such as this have lead to the suggestion that the treatment of obesity may be achieved by chemical approaches. Since then, a number of such chemical treatments have entered the market. The most famous of these attempts was the introduction of Fen-Phen, a combination of fenfluramine and phentermine. Unfortunately, it was discovered that fenfluramine caused heart-valve complications, which in some cases resulted in the death of the user. There has been some limited success with other combination therapy approaches, particularly in the field of psychological eating disorders. One such example is the combination of phentermine and fluoxetine, which showed some efficacy in the treatment of binge eating disorders. Due to the many adverse effects often associated with the use of synthetic chemicals, i.e. pharmaceuticals, natural products, such as plant extracts, have become popular alternatives to many pharmaceutical compounds.

The majority of both pharmaceuticals and nutraceuticals are administered orally to individuals in solid dosage forms, e.g. caplets and tablets. However, many people have problems swallowing large tablets or capsules, resulting in smaller dosing capacities in order to limit the size of the solid dosage form. Additionally, slow dissolution times of solid dosage forms in the stomach often lead to poor absorption of the active ingredients, and result in the required administration of the dose at times between 30 minutes and one hour prior to a meal.

Given the prevalence and serious problems associated with obesity, and the significant drawbacks associated with typical weight loss dosage forms, a need exists for a means to successfully orally administer dietary ingredients and compositions to persons that are overweight or obese to reduce weight gain, cause weight loss, and reduce body mass index to acceptably healthy levels.

### SUMMARY OF THE INVENTION

The present invention is directed towards an effervescent dietary composition comprising an effective amount of an extract of Cissus quadrangularis, an effective amount of caffeine, an effective amount of an extract of green tea and at least two ingredients capable of reacting to produce effervescence upon introduction into an aqueous solution.

In an additional embodiment of the present invention the effervescent dietary composition comprises an effective amount of a source of hydroxycitric acid, an effective amount of caffeine, an effective amount of an extract of green tea and at least two ingredients capable of reacting to produce effervescence upon introduction into an aqueous solution.

In still a further embodiment of the present invention the effervescent dietary composition comprises an effective amount of a source of corosolic acid, and at least two ingredients capable of reacting to produce effervescence upon introduction into an aqueous solution.

### DETAILED DESCRIPTION OF THE INVENTION

The inventors herein disclose that a dietary ingredient or a combination of dietary ingredients may be uniformly and accurately dispensed when completely dissolved in an aqueous medium, particularly in water. More specifically, the dietary ingredient or combinations of dietary ingredients have been formed into an effervescent tablets or granular powders which will act to enhance the delivery dietary ingredients or combinations of dietary ingredients in a human.

As used herein, the term “dietary ingredient” refers to ingestible substances which are capable of eliciting weight loss, controlling weight gain, and/or reducing body mass index to acceptably healthy levels. More specifically, as used herein, the term “dietary ingredient” refers to ingestible substances which act to control blood glucose levels, affect fat metabolism/lipolysis, suppress appetite, or increase thermogensis.

As used herein, typical “dietary ingredients” may include extracts of Cissus quadrangularis, caffeine, extracts of Green Tea, hydroxycitric acid, hydroxycitric acid salts (e.g. double-metal salts, tri-metal salts, or tetra-metal salts), sources of hydroxycitric acid (e.g. Garcinia cambogia, Garcinia indica, and Garcinia atrovirdis), corosolic acid, and sources of corosolic acid (e.g. Lagerstroemia speciosa, and Crataegus pinnatifida).

As used herein, the term “effervescence” refers to the generation of bubbles in an aqueous media. More specifically, the term “effervescence” refers to a reaction which generates bubbles, usually carbon dioxide, in aqueous media, preferably water. Furthermore, as used herein, the term “effervescent” refers to the quality of effervescence as described above. In particular, the term “effervescent” refers to oral dosage forms which, upon contact with water, react to liberate carbon dioxide. Effervescent oral dosage forms are generally powders and tablets. One of the earliest commercial applications of effervescence for the delivery of active agents is Alka-Seltzer® for the treatment of upset stomach and headache.

Effervescence is due to an acid-base-type reaction in which the acid and base components need not be active agents in the effervescent oral dosage forms, but must be present in sufficient quantities to produce effervescence. Effervescent oral dosage forms may contain other non-active ingredients as would be known commonly in the art, such as coloring agents, flavoring agents and, in the case of tablets, binding agents.

The soluble effervescent, as used herein, will contain mixtures of acids (including but not limited to citric acid, malic acid, tartaric acid, adipic acid and/or fumaric acid) and basic salts (including but not limited to sodium bicarbonate, sodium carbonate, potassium bicarbonate, and/or potassium carbonate), which releases carbon dioxide when dissolved in water.

Most types of active agents such as amino acids, vitamins/minerals, herbal extracts and pharmaceuticals are compatible with effervescent delivery formats. The delivery of active agents by effervescent oral dosage forms offers multiple advantages over other oral dosage forms.

The chief advantage offered by effervescent oral dosage forms is improved absorption of active agents. Since effervescent oral dosage forms are dissolved in water prior to ingestion, there is no need for the oral dosage form to dissolve in the stomach where slow dissolution times lead to poor absorption of active ingredients. Also, effervescent formulations can be buffered to a specific pH, further aiding absorption of active agents. By buffering effervescent formulations at a specific pH, the solubility of active agents can be maximized to allow for better absorption. Research also suggests that effervescence enhances the penetration of active agents across intestinal epithelial cells via the paracellular route (Eichman J D, Robinson J R. Mechanistic studies on effervescent-induced permeability enhancement. Pharm Res. June 1998;15(6):925-30).

Additionally, the use of an effervescent tablet, or packet of premeasured effervescent powder, assures complete and uniform dispersal of the dietary ingredient in the aqueous medium, by virtue of the effervescence of the liquid. This offers the additional advantage of improved administration due to the avoidance of swallowing problems associated with large tablets or capsules and a relatively large dosing capacity compared to normal tablets, capsules or caplets.

The present invention relies upon the combination of a dietary ingredient within an effervescent to create a solution which is ingested by the consumer. The effervescence acts to enhance the penetration of active agents across intestinal epithelial cells and increase the uniformity of the dispersal of the dietary ingredient in the aqueous medium. Thus, in its most general form, the invention includes a soluble effervescent comprising a dietary ingredient, an acid, or mixture of acids, and a basic salt or mixture of basic salts for releasing carbon dioxide when dissolved in a neutral pH liquid, such as water.

While the effervescent is preferably in the form of a tablet, it may also be utilized in granular/powder form. The effervescent must be stored in a tightly closed container or other moisture-proof package, since water or other liquids will activate the effervescent. This is beneficial, because it permits a predetermined, premeasured amount of a dietary ingredient and effervescent to be meted out within a package. In this way, the consumer will always receive the exact dosage of the dietary ingredient desired, whether in tablet form or granular/powder form.

The effervescent compositions are not to be swallowed directly, following their addition to an aqueous medium, since they release carbon dioxide as they dissolve. Thus, once the effervescent dietary composition has completely dissolved, the solution should be swallowed immediately. Preferably, the solution is ingested within 15 minutes of being completely dissolved in the liquid.

Whereas the invention has been shown and described in connection with the preferred embodiment thereof, many modifications, substitutions and additions may be made which are within the intended scope of the appended claims.

### EXAMPLES

### Example 1

An effervescent dietary composition comprising the following ingredients per serving are prepared for consumption as two tablets to be dissolved in water before meals:

from about 0.100 g to about 0.200 g of an extract of Cissus quadrangularis, from about 0.050 g to about 0.500 g of Caffeine, from about 0.100 g to about 0.500 g of an extract of Green Tea, from about 0.100 g to about 1.000 g of Sodium Bicarbonate, and from about 0.100 g to about 1.000 g of Citric acid.

Directions: As an effervescent dietary supplement, 2 caplets are added to an 8 oz. glass of water two (2) times daily. Each serving is consumed within 15 minutes of complete dissolution of the tablets and approximately 15 to 30 minutes before meals.

### Example 2

An effervescent dietary composition comprising the following ingredients per serving are prepared for consumption as two tablets to be dissolved in water before meals:

about 0.150 g of an extract of Cissus quadrangularis (stem and leaves) which is standardized for 2.5% phytosterols, about 0.250 g of Caffeine Anhydrous, about 0.1222 g of an extract of Green Tea (Camellia sinensis) which is standardized for 90% polyphenols, 45% epigallocatechin gallate, about 0.620 g of Sodium Carbonate, and about 0.600 g of Fumaric acid.

Directions: As an effervescent dietary supplement, 2 tablets are added to an 8 oz. glass of water two (2) times daily. Each serving is consumed within 15 minutes of complete dissolution of the tablets and approximately 15 to 30 minutes before meals.

### Example 3

An effervescent dietary composition comprising the following ingredients per serving are prepared for consumption as a powder, which is packaged into individual serving packages, to be dissolved in water before meals:

about 0.150 g of an extract of Cissus quadrangularis (stem and leaves), about 0.300 g of Caffeine Anhydrous, about 0.460 g of an extract of Green Tea (Camellia sinensis) which is standardized for 90% polyphenols, 45% epigallocatechin gallate, 75% catechins, about 0.0050 g of Black pepper extract (Piper nigrum L.), about 0.540 g of Potassium Bicarbonate, and about 0.480 g of Adipic acid.

Directions: As an effervescent dietary supplement, contents of an entire package are dissolved in an 8 oz. glass of water two (2) times daily. Each serving is consumed within 15 minutes of complete dissolution of the contents of the package and approximately 15 to 30 minutes before meals.

### Example 4

An effervescent dietary composition comprising the following ingredients per serving are prepared for consumption as three tablets to be dissolved in water before meals:

about 0.150 g of an extract of Cissus quadrangularis (stem and leaves) which is standardized to 2.5% phytosterols, about 0.200 g of Caffeine Anhydrous, and about 0.1222 g of an extract of Green Tea (Camellia sinensis) which is standardized for 90% polyphenols, 45% epigallocatechin gallate, about 0.0015 g of Chromium Polynicotinate, about 0.660 g of Potassium Carbonate, and about 0.620 g of Malic acid.

Directions: As an effervescent dietary supplement, 3 tablets are dissolved in an 8 oz. glass of water two (2) times daily. Each serving is consumed within 15 minutes of complete dissolution of the tablets and approximately 15 to 30 minutes before meals.

### Example 5

An effervescent dietary composition comprising the following ingredients per serving are prepared for consumption as a powder, which is packaged into individual serving packages, to be dissolved in water before meals:

from about 1.250 g to about 1.750 g of a source of hydroxycitric acid, from about 0.050 g to about 0.500 g of Caffeine Anhydrous, from about 0.100 g to about 0.500 g of an extract of Green Tea (Camellia sinensis) which is standardized for 90% polyphenols, 45% epigallocatechin gallate, 75% catechins, from about 0.100 g to about 1.000 g of Sodium Bicarbonate, and from about 0.100 g to about 1.000 g of Citric acid.

Directions: As an effervescent dietary supplement, contents of an entire package are dissolved in an 8 oz. glass of water two (2) times daily. Each serving is consumed within 15 minutes of complete dissolution of the contents of the package and approximately 15 to 30 minutes before meals.

### Example 6

An effervescent dietary composition comprising the following ingredients per serving are prepared for consumption as a powder, which is packaged into individual serving packages, to be dissolved in water before meals:

about 1.182 g of an extract of Garcinia cambogia which is standardized to 60% hydroxycitric acid, about 0.156 g of Calcium Hydroxycitrate, about 0.218 g of Potassium Hydroxycitrate, about 0.200 g of Caffeine Anhydrous, about 0.204 g of an extract of Green Tea (Camellia sinensis) which is standardized for 98% polyphenols, 45p% epigallocatechin gallate, 75% catechins, about 0.620 g of Sodium Bicarbonate, and about 0.600 g of Citric acid.

Directions: As an effervescent dietary supplement, contents of an entire package are dissolved in an 8 oz. glass of water two (2) times daily. Each serving is consumed within 15 of complete dissolution of the contents of the package and approximately 15 to 30 minutes before meals.

### Example 7

An effervescent dietary composition comprising the following ingredients per serving are prepared for consumption as two tablets to be dissolved in water before meals:

about 1.555 g of an extract of Garcinia cambogia which is standardized to 60% hydroxycitric acid, about 0.1555 g of Calcium Hydroxycitrate, about 0.2177 g of Potassium Hydroxycitrate, about 0.200 g of Caffeine Anhydrous, about 0.204 g of an extract of Green Tea (Camellia sinensis) which is standardized for 90% polyphenols, 45% epigallocatechin gallate, 75% catechins, about 0.1330 g of an extract of Gymnema sylvestre leaf which is standardized to 25% gymnemic acids, about 0.540 g of Potassium Bicarbonate, and about 0.480 g of Tartaric acid.

Directions: As an effervescent dietary supplement, 2 tablets are dissolved in an 8 oz. glass of water two (2) times daily. Each serving is consumed within 15 minutes complete dissolution of the tablets and approximately 15 to 30 minutes before meals.

### Example 8

An effervescent dietary composition comprising the following ingredients per serving are prepared for consumption as a powder, which is packaged into individual serving packages, to be dissolved in water before meals:

from about 0.010 g to about 0.050 g of a source of corosolic acid, from about 0.100 g to about 1.000 g of Sodium Bicarbonate, and from about 0.100 g to about 1.000 g of Citric acid.

Directions: As an effervescent dietary supplement, contents of an entire package are dissolved in an 8 oz. glass of water two (2) times daily. Each serving is consumed within 15 minutes complete dissolution of the contents of the package and approximately 15 to 30 minutes before meals.

### Example 9

An effervescent dietary composition comprising the following ingredients per serving are prepared for consumption as a powder, which is packaged into individual serving packages, to be dissolved in water before meals:

about 0.024 g of an extract of Banaba Leaf (Lagerstroemia speciosa L.) which is standardized to 3% corosolic acid, about 0.620 g of Sodium Bicarbonate, and about 0.600 g of Citric acid.

Directions: As an effervescent dietary supplement, contents of an entire package are dissolved in an 8 oz. glass of water two (2) times daily. Each serving is consumed within 15 minutes of complete dissolution of the contents of the package and approximately 15 to 30 minutes before meals.

### Extensions and Alternatives

In the foregoing specification, the invention has been described with a specific embodiment thereof; however, it will be evident that various modifications and changes may be made thereto without departing from the broader spirit and scope of the invention.

What is claimed:

1. An effervescent dietary composition comprising:
from about 0.100 g to about 0.200 g of an extract of Cissus quadrangularis;
from about 0.050 g to about 0.500 of Caffeine;
from about 0.100 g to about 0.500 g of an extract of Green Tea; and
at least two ingredients capable of reacting to produce effervescence upon introduction to an aqueous solution.

2. The composition of claim 1, wherein the two ingredients capable of reacting to produce effervescence upon introduction to an aqueous solution comprise at least an acidic component and a basic component.

3. The composition of claim 2, wherein the acidic component is selected from the group consisting of citric acid, malic acid, tartaric acid, adipic acid and fumaric acid.

4. The composition of claim 2, wherein the basic component is selected from the group consisting of sodium bicarbonate, sodium carbonate, potassium bicarbonate, and potassium carbonate.

5. The composition of claim 2, wherein the acidic component is citric acid and the basic component is sodium bicarbonate.

6. An effervescent dietary composition comprising:
from about 1.250 g to about 1.750 g of a source of hydroxycitric acid;
from about 0.050 g to about 0.500 of Caffeine;
from about 0.100 g to about 0.500 g of an extract of Green Tea; and
at least two ingredients capable of reacting to produce effervescence upon introduction to an aqueous solution.

7. The composition of claim 6, wherein the source of hydroxycitric acid is selected from the group consisting of an extract of Garcinia cambogia, an extract of Garcinia indica, an extract of Garcinia atrovirdis, a double salt of hydroxycitric acid, a tri-metal salt of hydroxycitric acid, and a tetra-metal salt of hydroxycitric acid.

8. The composition of claim 7, wherein the tri- and the tetra metal salts of hydroxycitric acid have at least three different metals selected from zinc, magnesium, sodium, potassium, and calcium.

9. The composition of claim 6, wherein the two ingredients capable of reacting to produce effervescence upon introduction to an aqueous solution comprise at least an acidic component and a basic component.

10. The composition of claim 9, wherein the acidic component is selected from the group consisting of citric acid, malic acid, tartaric acid, adipic acid and fumaric acid.

11. The composition of claim 9, wherein the basic component is selected from the group consisting of sodium bicarbonate, sodium carbonate, potassium bicarbonate, and potassium carbonate.

12. The composition of claim 9, wherein the acidic component is citric acid and the basic component is sodium bicarbonate.

13. An effervescent dietary composition comprising:
from about 0.010 g to about 0.050 g of a source of corosolic acid; and
at least two ingredients capable of reacting to produce effervescence upon introduction to an aqueous solution.

14. The composition of claim 13, wherein the source of corosolic acid is selected from the group consisting of an extract of Lagerstroemia speciosa (Banaba), and an extract of Crataegus pinnatifida (Hawthorn).

15. The composition of claim 13, wherein the two ingredients capable of reacting to produce effervescence upon introduction to an aqueous solution comprise at least an acidic component and a basic component.

16. The composition of claim 14, wherein the acidic component is selected from the group consisting of citric acid, malic acid, tartaric acid, adipic acid and fumaric acid.

17. The composition of claim 14, wherein the basic component is selected from the group consisting of sodium bicarbonate, sodium carbonate, potassium bicarbonate, and potassium carbonate.

18. The composition of claim 14, wherein the acidic component is citric acid and the basic component is sodium bicarbonate.
